(19) United States
(12) Patent Application Publication
(10) Pub. No.: US 2010/0201713 A1
(43) Pub. Date: Aug. 12, 2010

(54) IMAGE DISPLAY APPARATUS AND METHOD THEREOF

(75) Inventor: I-Min Lu, Xindian City (TW)

Correspondence Address: EGBERT LAW OFFICES, 412 MAIN STREET, 7TH FLOOR, HOUSTON, TX, 77002, US

(73) Assignee: MATRIXVIXION TECHNOLOGY Inc., Jhonghe City (TW)

(21) Appl. No.: 12/548,330

(22) Filed: Aug. 26, 2009

(30) Foreign Application Priority Data
Feb. 12, 2009 (TW) 098104555

(51) Int. Cl. G09G 5/373

(52) U.S. Cl. 345/660

(57) ABSTRACT

The present invention discloses an image display apparatus and a method thereof. The image display apparatus having an output picture includes a receiver module and an operation module. The receiver module receives at least one image having a display proportion. The operation module splits the output picture to generate a plurality of display areas according to the display proportion, wherein the image is displayed in the plurality of display areas.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates an image display apparatus and a method thereof, and more particularly to an image display apparatus splitting into a plurality of display areas according to the display proportion of a received image and a method thereof.

2. Description of Related Art Including Information Disclosed Under 37 CFR 1.97 and 37 CFR 1.98.

With people's emphasis on the quality of video entertainment and the popularity of high quality image service, such as DVD, HDTV, etc., a 16:9 or 16:10 widescreen liquid crystal display or television has been gradually accepted by users. It even has caused a fashion trend.

However, the dimensions of existing common images or films, such as television images, have display proportions that are mostly equal to the display proportion of a traditional screen (Currently, the display proportions of television images are 4:3). When a user desires to play a common image or a film on a widescreen display, the image of a 4:3 display proportion cannot be perfectly displayed on the output picture of the widescreen display. In this case, one method is that the input image of a 4:3 display proportion will be extended to the 16:9 display proportion of a full-screen mode and played so when the displayed image such as a person's image is displayed, the shape of the person on the screen is extended and present in a podgy state. Another method is that the image is enlarged according to the 4:3 display proportion. In such a method, black edges appear on both the left and right sides of the output picture, which decrease the availability of the output picture and give a viewer a bad feeling.

### BRIEF SUMMARY OF THE INVENTION

In view of the above problems of the prior art, an object of the present invention is to provide an image display apparatus and a method thereof such that various images (especially the images of a 4:3 display proportion) can be presented on a widescreen image display apparatus without distortion and the output picture of the entire screen can be sufficiently utilized.

Another object of the present invention is to provide an image display apparatus, wherein the output picture split by the image display apparatus further includes a menu display area.

To accomplish the above object, the present invention provides an image display apparatus including a receiver module and an operation module. The receiver module receives at least one image having a display proportion. The operation module splits the output picture to generate a plurality of display areas according to the display proportion wherein the image is displayed in the plurality of display areas.

To accomplish the above object, the present invention provides an image display method including the following steps. First, at least one image having a display proportion is received. Next, an operation module splits the output picture to generate a plurality of display areas according to the display proportion. Lastly, the image is displayed in the display areas.

As described above, the image display apparatus and the method thereof according to the present invention may have one or more following advantages:
(1) Images of various display proportions can be displayed on the image display apparatus without distortion.
(2) The split output picture further includes a menu display area which displays various functions of an on-screen display (OSD).

### BRIEF DESCRIPTION OF THE SEVERAL VIEWS OF THE DRAWINGS

FIG. 1 is a block diagram of an embodiment of an image display apparatus according to the present invention.

FIG. 2 is a schematic view of an embodiment of an image display apparatus according to the present invention.

FIGS. 3a to 3g are schematic views of examples of each split mode of image display apparatuses according to the present invention.

FIG. 4 is a schematic view showing the steps of an image display method according to the present invention.

### DETAILED DESCRIPTION OF THE INVENTION

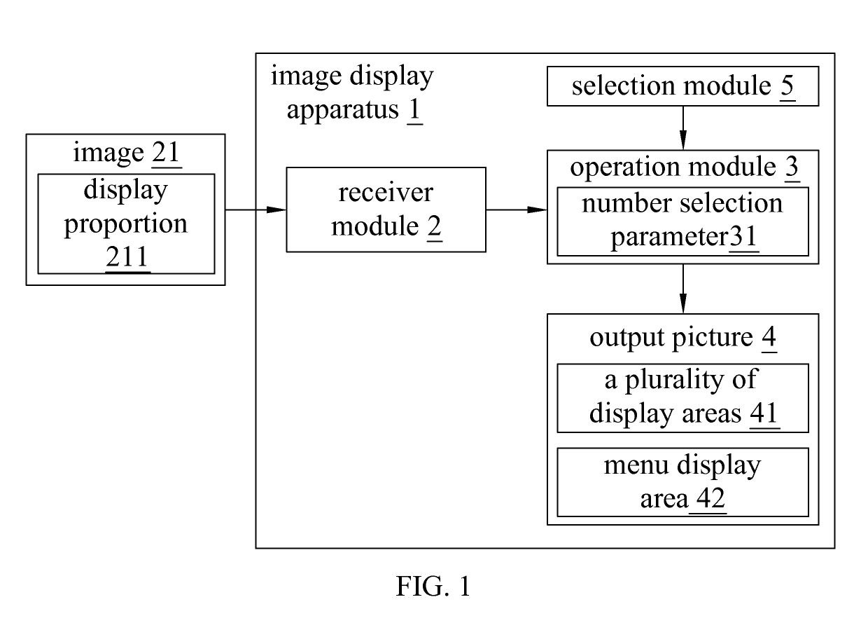

Referring to FIG. 1, illustrated is a block diagram of an embodiment of an image display apparatus according to the present invention. In this figure, an image display apparatus 1 includes a receiver module 2, an operation module 3 and a selection module 5. The receiver module 2 receives at least one image 21 having a display proportion 211. The receiver module 2 can receive images 21 of various display proportions 211 (e.g. 3:2, 4:3, 5:4, 16:9 or 16:10) sent from various image generation apparatuses, such as video compact discs (VCD), digital versatile discs (DVD), surveillance cameras or television stations.

The operation module 3 can split the output picture 4 from the image display apparatus 1 into a plurality of display areas 41 according to the display proportion 211 of the received image 21. The plurality of display areas 41 are the same as the display proportions 211 of the received image 21. The image 21 can be displayed in one of the plurality of display areas 41. When a plurality of images 21 are received, they can be respectively displayed in the plurality of display areas 41. In addition to the display areas 41, the split output picture 4 can contain areas whose display proportions do not coincide with that of the received image. The remaining area can be used as a menu display area 42.

The operation module 3 can further generate a corresponding number of display areas according to a number selection parameter 31 in addition to the display proportion 211. The number selection parameter 31 can be a split number self-preset by the apparatus or a number of display areas to be split inputted by a user. If it is desired to simultaneously watch the television programs on 5 channels, for example, the number selection parameter 31 of 5 can be inputted into the operation module 3. The number selection parameter 31 can also be changed according to the number of the images received by the receiver module 2. For example, the receiver module 2 receives the images 21 sent from five monitors so that the number selection parameter 31 is 5. Afterwards, the operation module 3 can split the output picture 4 into five display areas which coincide with the display proportion 211 according to the number selection parameter 31.

The selection module 5 is used to generate a selection instruction to the operation module 3 such that the operation module 3 can select and display the image 21 in one of the plurality of display areas 41 according to the selection instruction. The selection module 5 can generate a selection instruction to display the interested image 21 in a larger display area 41 according to the instruction inputted by a user, or the selection module 5 can further self-determine whether the content of the image 21 changes or not. If the content of the image 21 changes, a selection instruction is generated to display the changing image 21 in a larger display area 41.

The present invention is characterized by the following: if the display proportion 211 of the image 21 received by the receiver module 2 is different from that of the output picture 4, for example, the received image 21 is a general television image having a display proportion 211 of 4:3, the operation module 3 can split a 16:9 output picture 4 into a plurality of display areas 41 having a 4:3 display proportion 211 or a plurality of proportionally enlarged or reduced display areas 41 according to the present invention when it is desired to display the image 21 on the output picture 4 of a widescreen display whose display proportion 211 is, for example, 16:9. Thus, the display proportion 211 of the received image 21 will not be changed because the display proportion 211 of the received image 21 is different from that of the output picture 4 so as not to cause distortion in displaying the image 21.

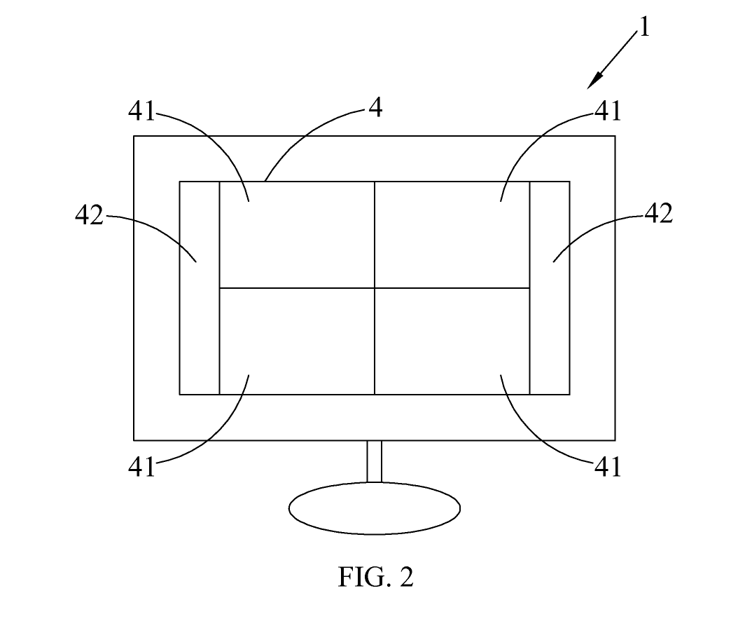

Referring to FIG. 2, illustrated is a schematic view of an embodiment of an image display apparatus according to the present invention. In this figure, the output picture 4 after split by the operation module contains remaining areas which cannot be split according to the display proportion besides the display areas 41 which coincide with the display proportion of the received image. The remaining area can be used as a menu display area 42 to display, for example, various operation function icons of an on-screen display, like the parameter values such as image contrast, brightness, volume, time and so forth according to the present invention. Alternatively, a time axis icon can be displayed to allow a user to know the current time point of the image playback when seeing a recorded image and has functions convenient to rewind or fast forward the image, etc. Moreover, a touch panel can be disposed on the menu display area 42 to serve as operation function keys such as a pause key of the image display apparatus 1. It is intended to utilize the entire output picture 4 as much as possible rather than display black edges on the output picture 4 to occupy the picture for the purpose as described above. If the output picture 4 can be completely split into the display areas 41 with no remaining areas, the display areas 41 can also be selected to serve as a menu display area 42.

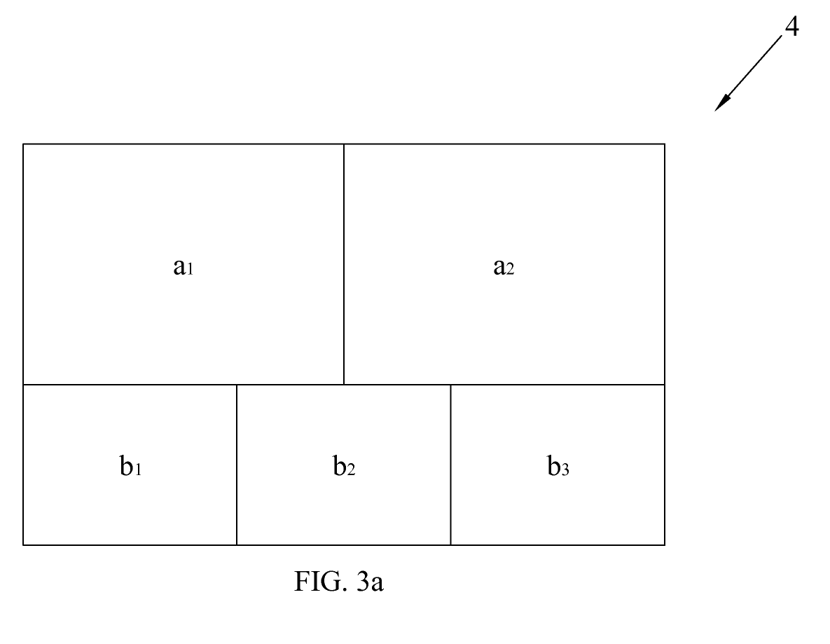

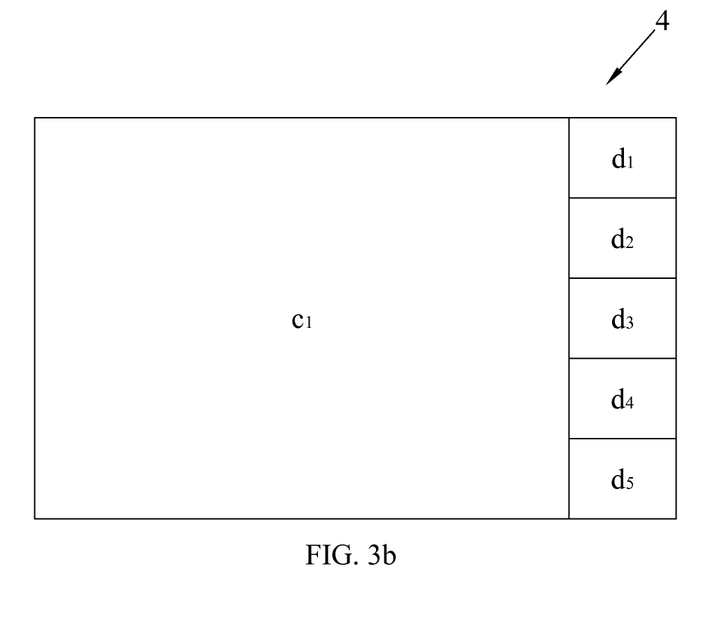

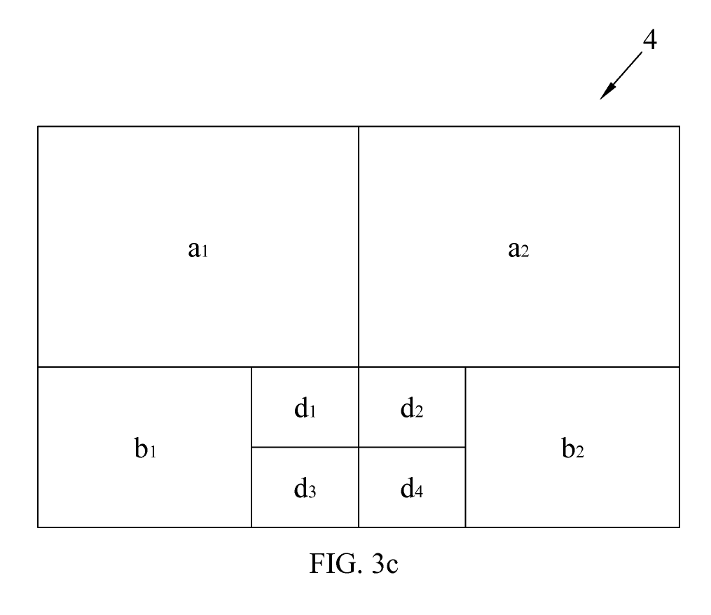

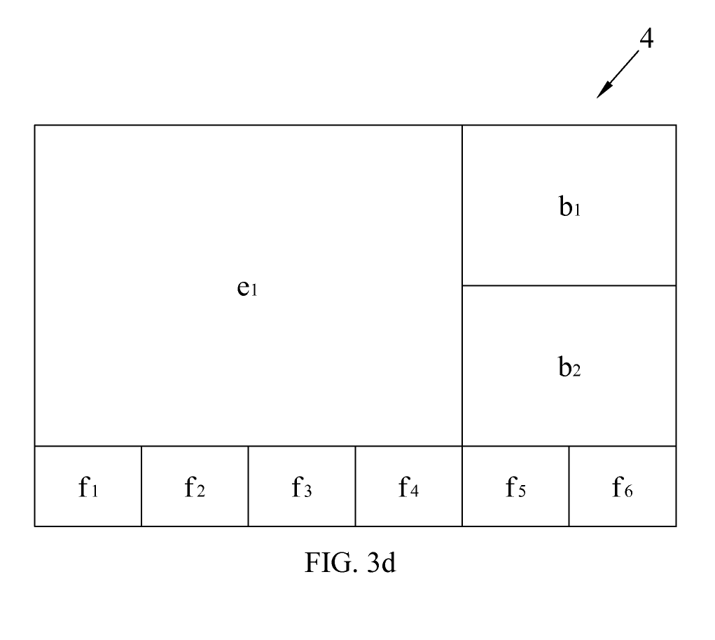

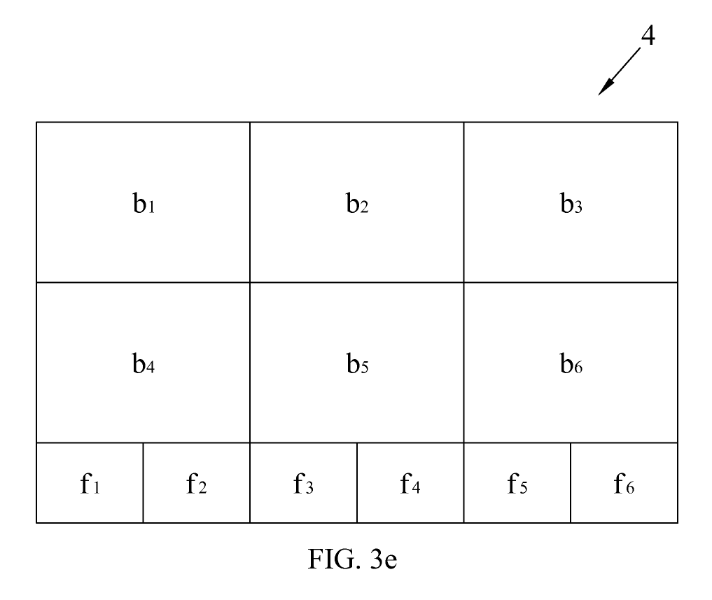

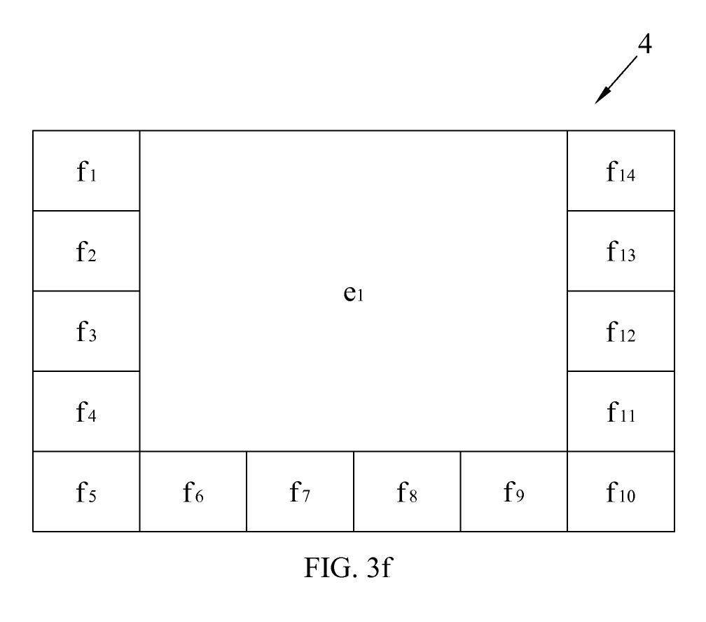

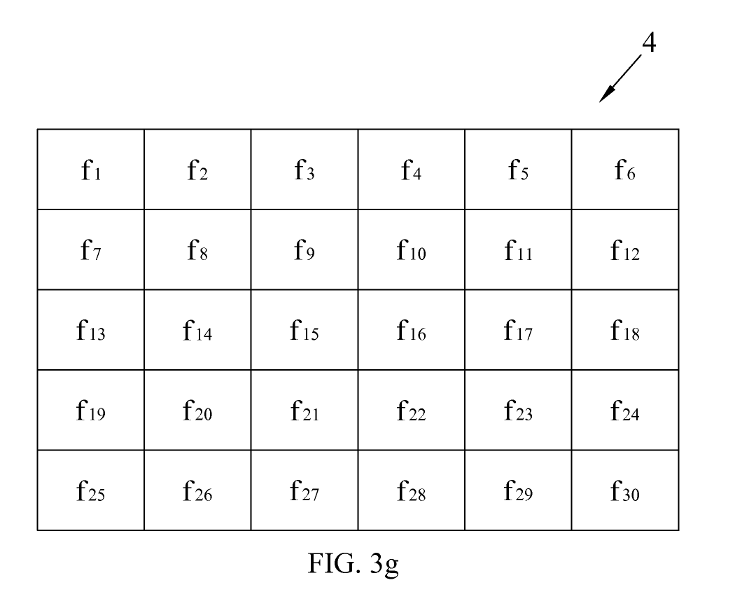

Referring to FIG.3a, illustrated is a split mode in which the output picture 4 having a display proportion of 16:10 is split into five display areas of a 4:3 display proportion, wherein the display proportions of the display areas a1 and a2 are 8:6=4:3 and the display proportions of the display areas b1 to b3 are 16/3:4=4:3.

FIG. 3b shows a split mode in which the 16:10 output picture 4 is split into six display areas of a 4:3 display proportion, wherein the display proportion of the display area c1 is 40/3:10=4:3 and the display proportions of the display areas d1 to d5 are 8/3:2=4:3.

FIG. 3c shows a split mode in which the 16:10 output picture 4 is split into eight display areas of a 4:3 display proportion, wherein the display proportions of the display areas a1 and a2 are 8:6=4:3, the display proportions of the display areas b1 and b2 are 16/3:4=4:3 and the display proportions of the display areas d1 to d4 are 8/3:2=4:3.

FIG. 3d shows a split mode in which the 16:10 output picture 4 is split into nine display areas of a 4:3 display proportion, wherein the display proportion of the display area e1 is 32/3:8=4:3, the display proportions of the display areas f1 to f6 are 16/6:2=4:3 and the display proportions of the display areas b1 and b2 are 16/3:4=4:3.

FIG. 3e shows a split mode in which the 16:10 output picture 4 is split into twelve display areas of a 4:3 display proportion, wherein the display proportions of the display areas b1 to b6 are 16/3:4=4:3 and the display proportions of the display areas f1 to f6 are 16/6:2=4:3.

FIG. 3f shows a split mode in which the 16:10 output picture 4 is split into fifteen display areas of a 4:3 display proportion, wherein the display proportion of the display area e1 is 32/3:8=4:3 and the display proportions of the display areas f1 to f14 are 16/6:2=4:3.

FIG. 3g shows a split mode in which the 16:10 output picture 4 is split into thirty display areas of a 4:3 display proportion, wherein the display proportions of the display areas f1 to f30 are 16/6:2=4:3. The various split modes of the output picture 4 presented in FIG. 3a to FIG. 3g are only examples and are not intended to limit the present invention.

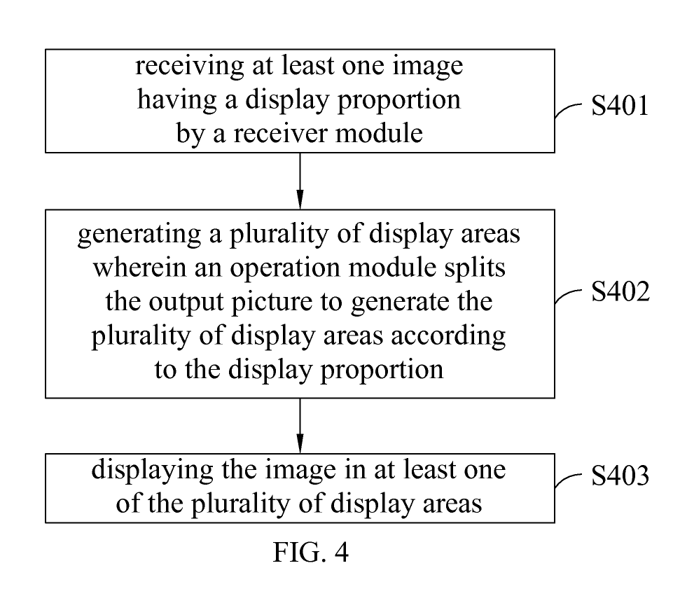

Referring to FIG. 4, there is a schematic view showing the steps of an image display method for use with an image display apparatus having an output picture according to the present invention, the image display method including the following steps:
Step S401: receiving at least one image having a display proportion by a receiver module.
Step S402: generating a plurality of display areas wherein an operation module splits the output picture to generate the plurality of display areas according to the display proportion.
Step S403: displaying the image in at least one of the plurality of display areas.

In practical application, a liquid crystal display is taken as an example, and the display proportion of the output picture on the liquid crystal display is, for example, 16:10 (widescreen display). According to the above steps, an image sent from the external is first received in step S401. The image is, for example, a television signal, an image of a 4:3 display proportion. In step S402, an operation module splits the output picture in a 4:3 display proportion or its magnification to generate a plurality of display areas of a 4:3 display proportion on the output picture. If there are remaining areas on the split output picture, they can serve as menu display areas to display various operation function icons of the parameter values such as the image contrast, brightness, volume, time or the like of an on-screen display. Alternatively, a touch panel is further disposed to serve as operation function keys of the image display apparatus. Prior to step S402, a number selection parameter and a selection instruction can be further accessed. The number selection parameter records the number of display areas to be split. The operation module generates a corresponding number of display areas which coincide with the display proportion according to the number selection parameter and the display proportion. The selection instruction is generated by a selection module. The operation module can select and display the received image in which position of the plurality of display areas according to the selection instruction, for example, display an image interested by a user or a content-changing image (e.g. a picture of a monitor) in a larger display area. Lastly, in step S403, the television signal of a 4:3 display proportion can be displayed in at least one of the display areas or the image can be displayed in a specific display area according to the selection instruction.

As concluded from the above, the function of the image display apparatus and the method thereof according to the present invention lies in that the output picture is appropriately split (especially in the case where the display proportion of the output picture is different from that of the received image) into a plurality of display areas which coincide with the display proportion of the received image or its magnification according to the display proportion of the received image. No matter what kind of display proportion of a screen (particularly a widescreen display) used, the integrity of an input image can be maintained and the output picture of the entire screen can be sufficiently utilized by displaying the image in a plurality of display areas.

The above description is illustrative only and is not to be considered limiting. Various modifications or changes can be made without departing from the spirit and scope of the invention. All such equivalent modifications and changes shall be included within the scope of the appended claims.

1. An image display apparatus having an output picture comprising:
a receiver module means for receiving at least one image having a display proportio; and
an operation module means for splitting the output picture according to the display proportion to generate a plurality of display areas which coincide with the display proportion, wherein the image is displayed in at least one of the plurality of display areas.

2. The image display apparatus as claimed in claim 1, further comprising:
a menu display area for the split output picture displayed an on-screen display.

3. The image display apparatus as claimed in claim 2, wherein the on-screen display is comprised of image contrast, brightness, volume, time, image pause or image rewind.

4. The image display apparatus as claimed in claim 1, wherein the operation module means further splits the output picture to generate a corresponding number of display areas according to a number selection parameter and the display proportion.

5. The image display apparatus as claimed in claim 4, wherein the number selection parameter is the number of the received images.

6. The image display apparatus as claimed in claim 4, wherein the number selection parameter is the inputted number of the display areas to be generated.

7. The image display apparatus as claimed in claim 1, further comprising:
a selection module means generating a selection instruction to the operation module means such that the operation module means selects and displays the image in at least one of the plurality of display areas according to the selection instruction.

8. The image display apparatus as claimed in claim 1, wherein the image display apparatus is comprised of a television set, a desktop computer or a portable electronic device.

9. The image display apparatus as claimed in claim 1, wherein the image display apparatus is comprised of a liquid crystal display, a plasma display or a light emitting diode display.

10. The image display apparatus as claimed in claim 1, wherein the display proportion of the output picture is different from a display proportion of the image.

11. The image display apparatus as claimed in claim 10, wherein the display proportion of the image is 4:3.

12. The image display apparatus as claimed in claim 10, wherein the display proportion of the output picture is 16:9 or 16:10.

13. An image display method for use with an image display apparatus having an output picture, the method comprising the steps of:
receiving at least one image having a display proportion by a receiver module;
generating a plurality of display areas wherein an operation module splits the output picture to generate the plurality of display areas according to the display proportion; and
displaying the image in at least one of the plurality of display areas.

14. The image display method as claimed in claim 13, wherein the split output picture further comprises a menu display area which displays an on-screen display (OSD).

15. The image display method as claimed in claim 14, wherein the on-screen display is comprised of image contrast, brightness, volume, time, image pause or image rewind.

16. The image display method as claimed in claim 13, wherein the operation module further splits the output picture to generate a corresponding number of display areas according to a number selection parameter and the display proportion.

17. The image display method as claimed in claim 16, wherein the number selection parameter is the number of the received images.

18. The image display method as claimed in claim 16, wherein the number selection parameter is the inputted number of the display areas to be generated.

19. The image display method as claimed in claim 13, further comprising the step of:
generating a selection instruction to the operation module such that the operation module selects and displays the image in at least one of the plurality of display areas according to the selection instruction.

20. The image display method as claimed in claim 13, wherein the image display apparatus is comprised of a television set, a desktop computer or a portable electronic device.

21. The image display method as claimed in claim 13, wherein the image display apparatus is comprised a liquid crystal display, a plasma display or a light emitting diode display.

22. The image display method as claimed in claim 13, wherein the display proportion of the output picture is different from a display proportion of the image.

23. The image display method as claimed in claim 22, wherein the display proportion of the image is 4:3.

24. The image display method as claimed in claim 22, wherein the display proportion of the output picture is 16:9 or 16:10.
